(19) United States
(12) Patent Application Publication
(10) Pub. No.: US 2013/0326113 A1
(43) Pub. Date: Dec. 5, 2013

(54) USAGE OF A FLAG BIT TO SUPPRESS DATA TRANSFER IN A MASS STORAGE SYSTEM HAVING NON-VOLATILE MEMORY

(71) Applicants: Nir Jacob Wakrat, Los Altos, CA (US); Andrew W. Vogan, San Jose, CA (US)

(72) Inventors: Nir Jacob Wakrat, Los Altos, CA (US); Andrew W. Vogan, San Jose, CA (US)

(73) Assignee: APPLE INC., Cupertino, CA (US)

(21) Appl. No.: 13/482,204

(22) Filed: May 29, 2012

(51) Int. Cl. G06F 12/00

(52) U.S. Cl. 711/103; 711/E12.008

(57) ABSTRACT

Systems and methods are disclosed for usage of a flag bit to suppress data transfer in a mass storage system having non-volatile memory (“NVM”). In some embodiments, a host of the system can issue queue-able trim commands by dispatching non-data transfer write commands to the NVM. In some embodiments, the host can track the read behavior of a particular application over a period of time. As a result, the host can maintain heuristics of logical sectors that are most frequently read together. The host can then notify the NVM to pre-fetch data that the application will most likely request at some point in the future. These notifications can take the form of non-data transfer read commands. Each non-data transfer read commands can include a flag bit that is set to indicate that no data transfer is desired.

### BACKGROUND OF THE DISCLOSURE

NAND flash memory, as well as other types of non-volatile memories (“NVMs”), are commonly used for mass storage. For example, consumer electronics such as portable media players often include flash memory to store music, videos, and other media.

Read and write commands can be issued in a device having an NVM, and these commands can be stored in a queue in volatile memory before being dispatched to the NVM. In some cases, a trim command may also be issued. A trim command can be used to invalidate the data stored in the NVM associated with one or more logical sectors. Before transmitting the trim command to the NVM, however, the device may be required to first drain the queue by clearing out all of the commands that are currently stored in the queue. This can be a cumbersome process, and may prevent the device from handling other commands while the queue is being drained.

Moreover, when the device issues a read command, a significant latency is introduced as the device waits for the NVM to return with data corresponding to the read command. That is, the NVM may need to fetch and transmit the data across a bus, which can cause substantial delays.

### SUMMARY OF THE DISCLOSURE

Systems and methods are disclosed for usage of a flag bit to suppress data transfer in a mass storage system having non-volatile memory (“NVM”). In some embodiments, a host of the system can issue queue-able trim commands by dispatching non-data transfer write commands to the NVM. Each non-data transfer write command can include a flag bit that is set to indicate lack of data association. In other words, the flag bit can indicate that no data is or will be associated with the non-data transfer write command.

In some embodiments, the host can track the read behavior of a particular application over a period of time. As a result of the tracking, the host can maintain heuristics of logical sectors that are most frequently read together. The host can then notify the NVM to pre-fetch data that the application will most likely request at some point in the future. These notifications can take the form of non-data transfer read commands, which can correspond to anticipatory fetch commands with no data transfer between the host and the NVM. Similar to non-data transfer write commands, each non-data transfer read command can include a flag bit that is set to indicate that no data transfer is desired.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIGS. 1 and 2 are block diagrams of electronic devices configured in accordance with various embodiments of the invention;

FIG. 3 is a flowchart of an illustrative process for dispatching access commands stored in a queue in accordance with various embodiments of the invention;

FIG. 4 is a graphical view of an illustrative timing diagram for a conventional system;

FIG. 5 is a graphical view of an illustrative timing diagram in accordance with various embodiments of the invention;

FIG. 6 is a graphical view of another illustrative timing diagram in accordance with various embodiments of the invention;

FIG. 7 is a flowchart of an illustrative process for dispatching one or more non-data transfer read commands from a host in accordance with various embodiments of the invention; and

FIGS. 8A and 8B are flowcharts of an illustrative process for handling non-data transfer read commands in accordance with various embodiments of the invention.

### DETAILED DESCRIPTION OF THE DISCLOSURE

Systems and methods for usage of a flag bit to suppress data transfer in a mass storage system having non-volatile memory (“NVM”) are provided. In some embodiments, an NVM interface of the system can issue queue-able trim commands by dispatching non-data transfer write commands to the NVM. Each non-data transfer write command can include a flag bit that is set to indicate lack of data association. In other words, the flag bit can indicate that no data is or will be associated with the non-data transfer write command.

In some embodiments, a host of the system can track the read behavior of a particular application over a period of time. As a result of this tracking, the host can maintain heuristics of logical sectors that are most frequently read together.

Consequently, upon receiving a data request corresponding to a logical sector (e.g., a particular LBA range) from the application, the host can determine additional logical sectors that are highly associated with the logical sector based on the heuristics. The host can then opportunistically dispatch one or more non-data transfer read commands corresponding to the additional logical sectors to the NVM. This then allows the NVM to pre-fetch data associated with the additional logical sectors without transmitting the data to the host.

These non-data transfer read commands can correspond to anticipatory fetch commands with no data transfer between the host and the NVM. Similar to non-data transfer write commands, each non-data transfer read command can include a flag bit that is set to indicate that no data transfer is desired.

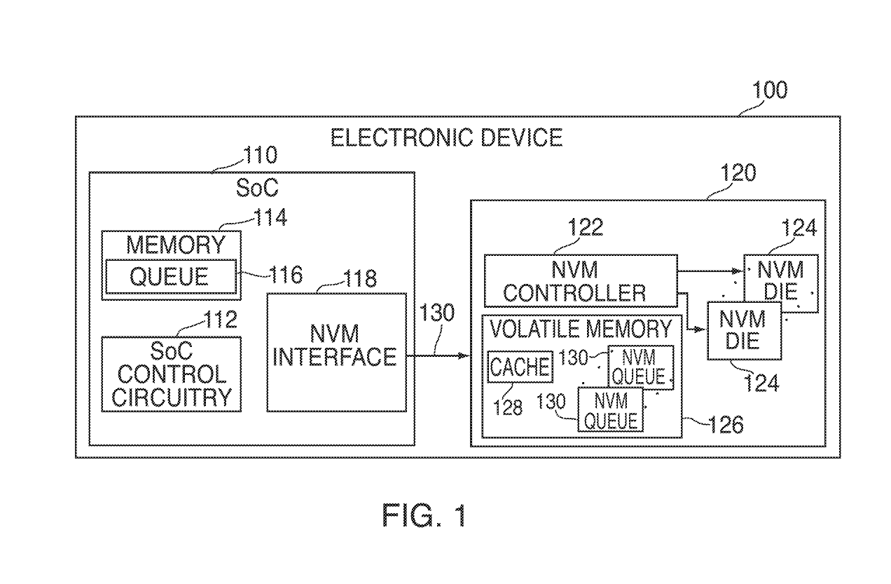

FIG. 1 illustrates a block diagram of electronic device 100. In some embodiments, electronic device 100 can be or can include a portable media player, a cellular telephone, a pocket-sized personal computer, a personal digital assistance (“PDA”), a desktop computer, a laptop computer, and any other suitable type of electronic device. In some embodiments, electronic device 100 can function as a mass storage system.

Electronic device 100 can include system-on-a-chip (“SoC”) 110 and non-volatile memory (“NVM”) 120. Non-volatile memory 120 can include multiple integrated circuit (“IC”) dies 124, which can be but is not limited to NAND flash memory based on floating gate or charge trapping technology, NOR flash memory, erasable programmable read only memory (“EPROM”), electrically erasable programmable read only memory (“EEPROM”), Ferroelectric RAM (“FRAM”), magnetoresistive RAM (“MRAM”), Resistive RAM (“RRAM”), or any combination thereof.

Each one of NVM dies 124 can be organized into one or more “blocks”, which can the smallest erasable unit, and further organized into “pages”, which can be the smallest unit that can be programmed or read. Memory locations (e.g., blocks or pages of blocks) from corresponding NVM dies 124 may form “super blocks”. Each memory location (e.g., page or block) of NVM 120 can be referenced using a physical address (e.g., a physical page address or physical block address). In some cases, NVM dies 124 can be organized for random reads and writes of bytes and/or words, similar to SRAM.

In some embodiments, NVM 120 can include NVM controller 122 that can be coupled to any suitable number of NVM dies 124. NVM controller 122 can include any suitable combination of processors, microprocessors, or hardware-based components (e.g., ASICs). In some cases, NVM controller 122 can translate logical addresses provided by SoC 110 to physical addresses associated with memory locations of NVM dies 124. NVM controller 122 can monitor the physical and logical attributes of data associated with commands received from SoC 110. In addition, NVM controller 122 can have information regarding the physical configurations of NVM dies 124 including, for example, the ability of particular NVM dies 124 to process data in a concurrent fashion.

NVM 120 can include volatile memory 126, which can be any suitable type of volatile memory, such as random access memory (“RAM”) (e.g., static RAM (“SRAM”), dynamic random access memory (“DRAM”), synchronous dynamic random access memory (“SDRAM”), double-data-rate (“DDR”) RAM), cache memory, read-only memory (“ROM”), or any combination thereof. Volatile memory 126 can include a data source (not shown in FIG. 1) that can temporarily store data before the data is programmed into the blocks of NVM 120. Furthermore, volatile memory 126 can include cache 128, which can store data after the data has been fetched from the blocks but prior to transmission to SoC 110. In addition, volatile memory 126 can include one or more NVM queues 130 (e.g., memory buffers such as pre-fetch SRAM buffers) that can store access commands received from SoC 110. In some cases, each NVM die 124 may be associated with its own NVM queue 130. Persons skilled in the art will appreciate that NVM 120 can also include one or more components not shown in FIG. 1.

System-on-a-chip 110 can include SoC control circuitry 112, memory 114, and NVM interface 118. SoC 110 may also sometimes be referred to as a “host”.

SoC control circuitry 112 can control the general operations and functions of SoC 110 and the other components of SoC 110 or device 100. For example, responsive to user inputs and/or the instructions of an application or operating system, SoC control circuitry 112 can issue read or write commands to NVM interface 118 to obtain data from or store data in NVM 120.

SoC control circuitry 112 can include any combination of hardware, software, and firmware, and any components, circuitry, or logic operative to drive the functionality of electronic device 100. For example, SoC control circuitry 112 can include one or more processors that operate under the control of software/firmware stored in NVM 120 or memory 114.

SoC control circuitry 112 can dispatch one or more commands to NVM 120. In some embodiments, SoC control circuitry 112 can include a block device driver or wrapper that can be configured to dispatch application programming interface (“API”) operations to NVM 120 or a controller of NVM 120. In some embodiments, SoC control circuitry 112 can modify one or more parameters of the block device driver or wrapper in order to transfer information to NVM 120. For example, by modifying the one or more parameters, SoC control circuitry 112 can transfer information associated with commands used to access NVM 120 (e.g., read, program, and/or trim commands).

Memory 114 can include any suitable type of volatile memory, such as random access memory (“RAM”) (e.g., static RAM (“SRAM”), dynamic random access memory (“DRAM”), synchronous dynamic random access memory (“SDRAM”), double-data-rate (“DDR”) RAM), cache memory, read-only memory (“ROM”), or any combination thereof. Memory 114 can include a data source that can temporarily store data for programming into or reading from non-volatile memory 120. In some embodiments, memory 114 may act as the main memory for any processors implemented as part of SoC control circuitry 112.

In some embodiments, memory 114 can include queue 116 for saving commands (e.g., read and/or write commands) received from a file system that have not yet been dispatched to NVM 120. At a suitable time, NVM interface 118 can scan queue 116 in order to select one or more commands that may be dispatched to NVM 120 over bus 130. In some embodiments, bus 130 can be a Serial Advanced Technology Attachment (“SATA”) bus. After the one or more commands have been dispatched, NVM interface 118 can remove those commands from queue 116. Queue 116 will generally be serviced until it is empty.

Queue 116 may have a pre-determined queue depth (e.g., one, two, three, etc.). For example, when a queue has a queue depth of one, input/outputs (“I/Os”) can be executed in a serial fashion. That is, NVM interface 118 may wait for a dispatched command to complete (e.g., wait for NVM 120 to either return data or to issue a message indicating that it has completed the command) before dispatching another command. As another example, when a queue has a queue depth of two, two outstanding I/Os can be pending at the same time. In particular, NVM interface 118 can dispatch two commands from the queue, and NVM 120 can have the option of performing the two commands in any suitable order. As a result, a queue having a queue depth of two is approximately twice as efficient as a queue having a queue depth of one.

In some embodiments, the queue depth of queue 116 may depend on the type of bus protocol that is used. For example, under a SATA bus protocol, the queue depth of queue 116 is pre-configured to have a maximum value of 32.

The command that is dispatched by NVM interface 118 from queue 116 can take any suitable form. In some cases, the command can take the form of an API operation with the following format:

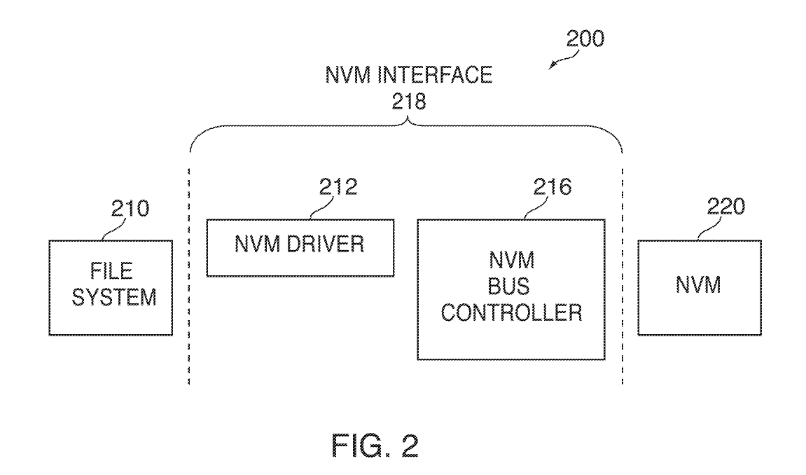

Command (LBA, size, tag, opCode) (1),

where LBA corresponds to the starting logical block address associated with the command, size corresponds to the range of the command, tag corresponds to an identifier associated with the command, and opCode corresponds to the type of command that is dispatched (e.g., a read command, a write command, or a miscellaneous command such as a trim command). Miscellaneous commands, and particularly trim commands, will be described in more detail in connection with FIG. 2.

The value of the tag parameter can depend on the queue depth. For example, if queue 116 has a queue depth of one, the tag associated with each dispatched command can have a tag value of one. As another example, if queue 116 has a queue depth of 32, the tag associated with each dispatched command can have a tag value between 0 and 31. In addition, commands of the same type (e.g., read, write, or miscellaneous commands) can share the same unique opCode.

NVM interface 118 may include any suitable combination of hardware, software, and/or firmware configured to act as an interface or driver between SoC control circuitry 112 and NVM 120. For any software modules included in NVM interface 118, corresponding program code may be stored in NVM 120 or memory 114.

NVM interface 118 can perform a variety of functions that allow SoC control circuitry 112 to access NVM 120 and to manage the memory locations (e.g., pages, blocks, super blocks, integrated circuits) of NVM 120 and the data stored therein. For example, NVM interface 118 can interpret the read or write requests from SoC control circuitry 112, perform wear leveling, and generate read and program instructions compatible with the bus protocol of NVM 120.

While NVM interface 118 and SoC control circuitry 112 are shown as separate modules, this is intended only to simplify the description of the embodiments of the invention. It should be understood that these modules may share hardware components, software components, or both. For example, SoC control circuitry 112 may execute a software-based memory driver for NVM interface 118.

In some embodiments, electronic device 100 can include a target device, such as a solid-state drive (“SSD”), a flash memory drive, or a Secure Digital (“SD”) card, that includes NVM 120 and some or all portions of NVM interface 118 (e.g., a translation layer, discussed below). In these embodiments, SoC 110 or SoC control circuitry 112 may act as the host controller for the target device. For example, as the host controller, SoC 110 can issue read and write requests to the target device.

FIG. 2 illustrates a block diagram of electronic device 200, which may illustrate in greater detail some of the firmware, software, and/or hardware components of electronic device 100 (FIG. 1) in accordance with various embodiments. Electronic device 200 may have any of the features and functionalities described above in connection with FIG. 1, and vice versa. As shown, dashed lines demarcate the layers. It is understood that the depiction of which components fall within the demarcation lines are merely illustrative and that one or more components can be affiliated with a different layer.

Electronic device 200 can include file system 210, NVM driver 212, NVM bus controller 216, and NVM 220. In some embodiments, file system 210 and NVM driver 212 may be software or firmware modules, and NVM bus controller 216 and NVM 220 may be hardware modules. Accordingly, in these embodiments, NVM driver 212 may represent the software or firmware aspect of NVM interface 218, and NVM bus controller 216 may represent the hardware aspect of NVM interface 218.

File system 210 can include any suitable type of file system, such as a File Allocation Table (“FAT”) file system or a Hierarchical File System Plus (“HFS+”), and may be part of the operating system of electronic device 200 (e.g., part of SoC control circuitry 112 of FIG. 1). In some embodiments, file system 210 may include a flash file system, which provides a logical to physical mapping of pages. In these embodiments, file system 210 may perform some or all of the functionalities of NVM driver 212 discussed below, and therefore file system 210 and NVM driver 212 may or may not be separate modules.

File system 210 may manage file and folder structures for the application and operating system. File system 210 may operate under the control of an application or operating system running on electronic device 200, and may provide write and read commands to NVM driver 212 when the application or operating system requests that information be read from or stored in NVM 220. Along with each read or write command, file system 210 can provide a logical address to indicate where the data should be read from or written to, such as a logical page address or a logical block address (“LBA”) with a page offset.

File system 210 may provide read and write requests to NVM driver 212 that are not directly compatible with NVM 220. For example, the logical addresses may use conventions or protocols typical of hard-drive-based systems. A hard-drive-based system, unlike flash memory, can overwrite a memory location without first performing a block erase. Moreover, hard drives may not need wear leveling to increase the lifespan of the device. Therefore, NVM interface 218 can perform any functions that are memory-specific, vendor-specific, or both to handle file system requests and perform other management functions in a manner suitable for NVM 220.

NVM driver 212 may interface with NVM bus controller 216 to complete NVM access commands (e.g., program, read, and trim commands). Bus controller 216 may act as the hardware interface to NVM 220, and can communicate with NVM 220 using the bus protocol (e.g., a SATA bus protocol), data rate, and other specifications of NVM 220.

As discussed previously, upon receiving a read or write command from file system 210, NVM interface 218 can store the read or write command in a queue (e.g., queue 116 of FIG. 1). Then, at a suitable time, NVM interface 218 can direct NVM bus controller 216 to dispatch a command from the queue to NVM 220 over a bus (e.g. bus 130 of FIG. 1).

In some embodiments, in addition to read and write commands, file system 210 can issue miscellaneous commands such as, for example, a smart command, an ID command, and a trim command. A trim command can be used to invalidate data stored in the NVM that is associated with one or more logical sectors. Each trim command that is issued can include a list of logical sectors (e.g., starting LBAs and associated sizes) that need to be invalidated.

Conventionally, miscellaneous commands are non-queue-able. That is, in order to transmit a miscellaneous command to the NVM, the device needs to first drain the queue by dispatching all of the commands that are currently stored in the queue. In addition, before transmitting the trim command, the device needs to wait for all of the dispatched commands to complete. This can be a cumbersome and time-consuming process, and may prevent the device from transmitting other I/Os over the bus while the queue is being drained.

Accordingly, by providing queue-able trim commands, the I/O efficiency of the system can be improved. In particular, queue-able trim commands can be implemented by adding a flag bit to a write command that is dispatched by an NVM interface (e.g., NVM interface 118 of FIG. 1 or NVM interface 218 of FIG. 2). That is, a queue-able trim command can take the form of a non-data transfer write command, where the flag bit can be set to indicate lack of data association (e.g., a no-data-phase value). In other words, the flag bit can indicate that no data is or will be associated with the non-data transfer write command. In addition, under such a configuration, the flag bit of a normal write command (e.g., a data transfer write command) can be set to indicate the presence of data association (e.g., a data-phase value). That is, the flag bit can indicate that data is or will be associated with the write command. In some embodiments, non-data transfer write commands can be assigned the same opCode as data transfer write commands.

The flag bit can be added to the write command in any suitable manner (e.g., at any suitable location). In some embodiments, the flag bit can be implemented as an additional parameter in the command format provided in Equation (1). In other embodiments, the flag bit can be implemented by modifying one or more parameters of the command format provided in Equation (1).

Because the trim command is queue-able, the NVM interface can dispatch the trim command from the queue in the same way as a read or write command (e.g., without first having to drain the queue). When an NVM (e.g., NVM 120 of FIG. 1 or NVM 220 of FIG. 2) receives the queue-able trim command, the NVM can automatically transmit a complete status to the NVM interface with zero delay. Thus, although the NVM may actually handle the queue-able trim command at a later time (e.g., execute the queue-able trim command concurrently with other commands), the queue-able trim command can be a zero-latency command from the perspective of the file system and the NVM interface. In embodiments where the NVM includes an NVM controller (e.g., NVM controller 122 of FIG. 1), the NVM controller can receive and handle the queue-able trim command.

In some embodiments, a queue-able trim command may allow the system to invalidate only one logical sector at a time. However, because the NVM interface can stack queue-able trim commands back-to-back, multiple logical sectors can be invalidated with the dispatch of multiple queue-able trim commands.

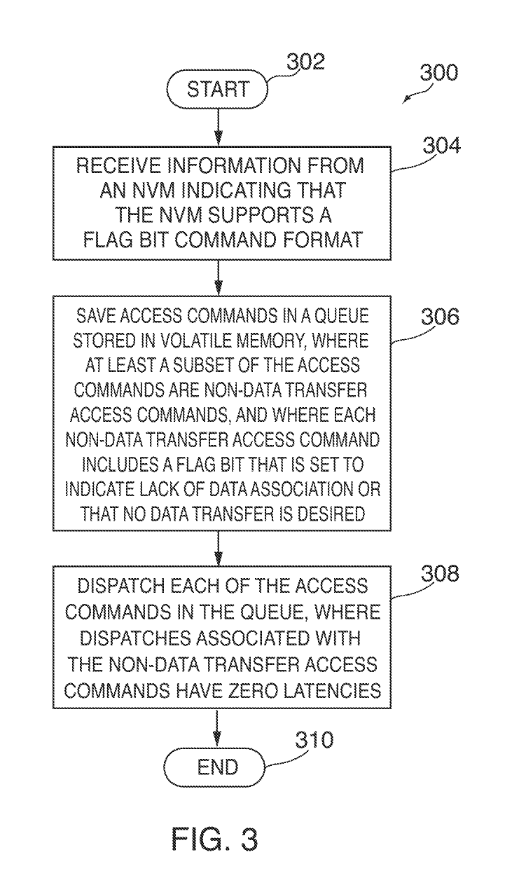

Referring now to FIG. 3, a flowchart of illustrative process 300 for dispatching access commands stored in a queue is shown. Process 300 may begin at step 302, and at step 304, an NVM interface (e.g., NVM interface (e.g., NVM interface 118 of FIG. 1 or NVM interface 218 of FIG. 2) can receive information from an NVM (e.g., NVM 120 of FIG. 1, NVM 220 of FIG. 2, or a component of the NVM such as NVM controller 122 of FIG. 1) indicating that the NVM supports a flag bit command format. In some embodiments, this can occur upon system power up during an identification scheme between the NVM and the NVM interface. Once the NVM interface receives information that the NVM supports the flag bit command format, the NVM interface can begin to dispatch access commands (e.g., read and write commands) with the flag bit format.

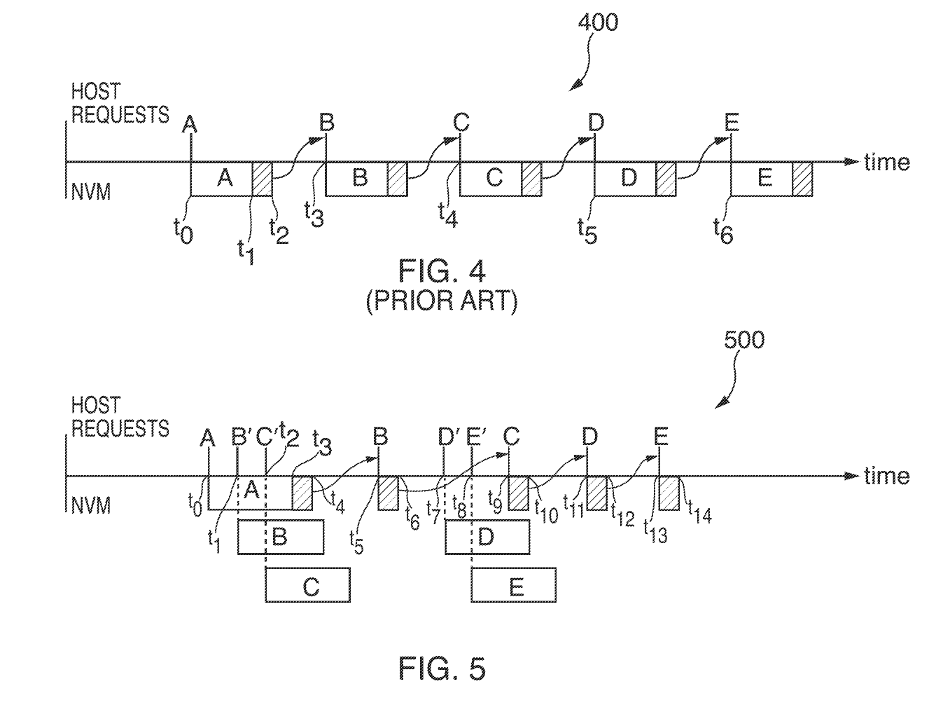

Continuing to step 306, the NVM interface can save access commands in a queue (e.g., queue 116 of FIG. 1) stored in volatile memory (e.g., memory 114 of FIG. 1), where at least a subset of the access commands are non-data transfer access commands, and further where each non-data transfer access command includes a flag bit that is set to indicate lack of data association or that no data transfer is desired (e.g., a no-data-phase value). For example, the non-data transfer access command can be a non-data transfer write command (e.g., a queue-able trim command), and the flag bit can be set to indicate lack of data association. As another example, the non-data transfer access command can be a non-data transfer read command, and the flag bit can be set to indicate that no data transfer is desired. Non-data transfer read commands may allow the system to perform predictive fetching. Non-data transfer read commands will be described in more detail in connection with FIGS. 4-8B.

At step 308, the NVM interface can dispatch each of the access commands in the queue, where dispatches associated with the non-data transfer access commands have zero latencies. For example, because the NVM (e.g., the NVM controller) can be configured to immediately transmit a complete status to the NVM interface upon receiving a non-data transfer write command, the NVM interface can receive the complete status from the NVM with no delay. As another example, because the NVM does not transmit any data to the NVM interface after processing non-data transfer read commands, non-data transfer read commands can be considered zero latency commands from the perspective of the NVM interface. Process 300 may end at step 310.

As discussed, non-data transfer read command can allow a system to perform predictive fetching. For example, turning now to FIGS. 4-6, graphical views of illustrative timing diagrams are shown. As illustrated in FIGS. 4-6, the graphical portions above the time axis can correspond to incoming host requests in the time domain, and the graphical portions beneath the time axis can correspond to NVM processing in the time domain. The NVM processing can be performed by any suitable component of a system such as, for example, a host control circuitry such as control circuitry 112 (FIG. 1) or an NVM controller such as NVM controller 122 (FIG. 1). For the sake of simplicity, however, the discussion below will refer to the NVM processing as being performed by an NVM.

In addition, un-shaded boxes in FIGS. 4-6 can indicate the time that it takes to fetch data from the NVM (e.g., perform data read, error-correcting code (“ECC”), etc.), and shaded boxes can indicate the time that it takes to transfer the data to the host.

Turning first to FIG. 4, a graphical view of illustrative timing diagram 400 for a conventional system is shown. As shown, the application can make a series of data requests for logical sectors of data (e.g., logical sectors A-E). A logical sector can correspond to a LBA range, and can be the smallest granular unit that can be read from and/or written to. A logical sector can have any suitable size such as, for example, 4K or 8K.

At t₀, in response to receiving a data request corresponding to logical sector A from an application, the host can transmit read command A to an NVM (e.g., NVM 120 of FIG. 1 or NVM 220 of FIG. 2) requesting data associated with logical sector A. Once the NVM receives the read command, the NVM can translate the associated logical address to a physical address, and fetch data associated with logical sector A (e.g., read data from one or more blocks of the NVM). After fetching the data, the NVM can perform any suitable processing of the data (e.g., ECC processing). Then, at t₁, the NVM can transmit the data to the host over a bus (e.g., bus 130 of FIG. 1), where the data can then be transferred into host memory (e.g., memory 114 of FIG. 1). This fetching and transmission process can produce a non-trivial delay (e.g., 60-70 μs). As a result, the corresponding data is not received at the host until t₂.

Likewise, at t₃, t₄, t₅, and t₆, the host can transmit read commands B-E associated with logical sectors B-E, respectively. The time interval between when data from a first read command is received by the host and when a second read command is dispatched by the host may be host-dependent (e.g., as indicated by the arrows in FIG. 4). That is, after receiving data corresponding to a particular read command, the application may need to process the data and then determine which read command(s) to issue next. For instance, after data associated with read command A has been transferred to the host, a particular amount of time (e.g., t₃−t₂) may elapse before read command B is transmitted to the NVM.

While the NVM is waiting for the host to transmit each read command, the NVM is functioning in an idle mode and is underutilized due to lack of concurrent behavior. Hence, in order to improve system efficiency, it would be desirable for the NVM to be able to execute other commands during this waiting period.

In addition, in response to each read command, the NVM needs to translate, fetch, and transmit data across the bus. The host may therefore encounter a similar delay for each read command. Consequently, in a conventional system, host requests can cause significant time delays due to latencies associated with fetching the data in the NVM and transferring the data to the host (e.g., SoC 110 of FIG. 1).

Accordingly, instead of waiting to receive data associated with each dispatched read command from an NVM, a host (e.g., any suitable component(s) of the host such as file system 210 of FIG. 2) can attempt to anticipate upcoming read commands. In particular, an application's data requests may fall into a non-random repeatable pattern over time. That is, each time an application is launched, the application can make data requests for the same logical sectors. Moreover, the order of these requests may be the same as or at least closely resemble previous data requests. Thus, by tracking the read behavior of an application over a period of time, the system can implement an intelligent pre-fetch model for host data requests. For example, a host can notify an NVM (e.g., NVM 120 of FIG. 1 or NVM 220 of FIG. 2) to pre-fetch data that the application will most likely request at some point in the future.

In some embodiments, the host can maintain heuristics (e.g., one or more vectors or counters) of the number of times that logical sectors are read consecutively. For example, each time that a logical sector A read is followed by a logical sector B read, the host can increment a “logical sector A-logical sector B” counter by one. In contrast, each time that a logical sector A read is followed by a read of a different logical sector, the host can decrement the “logical sector A-logical sector B” counter by one. If the counter reaches a pre-determined threshold (e.g., three), the host can determine that this particular pattern of read behavior is highly deterministic. That is, once the host receives a data request from an application for logical sector A, the host can expect to receive a subsequent data request for logical sector B.

These application heuristics (e.g., non-random read patterns) can be used when the host receives a data request corresponding to a logical sector (e.g., a particular LBA range) from the application. For example, in response to receiving a data request corresponding to a logical sector, the host can determine additional logical sectors that are highly associated with the logical sector. The host can then opportunistically dispatch one or more non-data transfer read commands corresponding to the highly associated logical sectors across a bus (e.g., bus 130 of FIG. 1) to the NVM. These non-data transfer read commands can correspond to anticipatory fetch commands with no data transfer between the host and the NVM. Similar to non-data transfer write command (e.g., queue-able trim commands), the host can provide non-data transfer read commands by adding a flag bit to a read command that is dispatched by an NVM interface (e.g., NVM interface 118 of FIG. 1 or NVM interface 218 of FIG. 2).

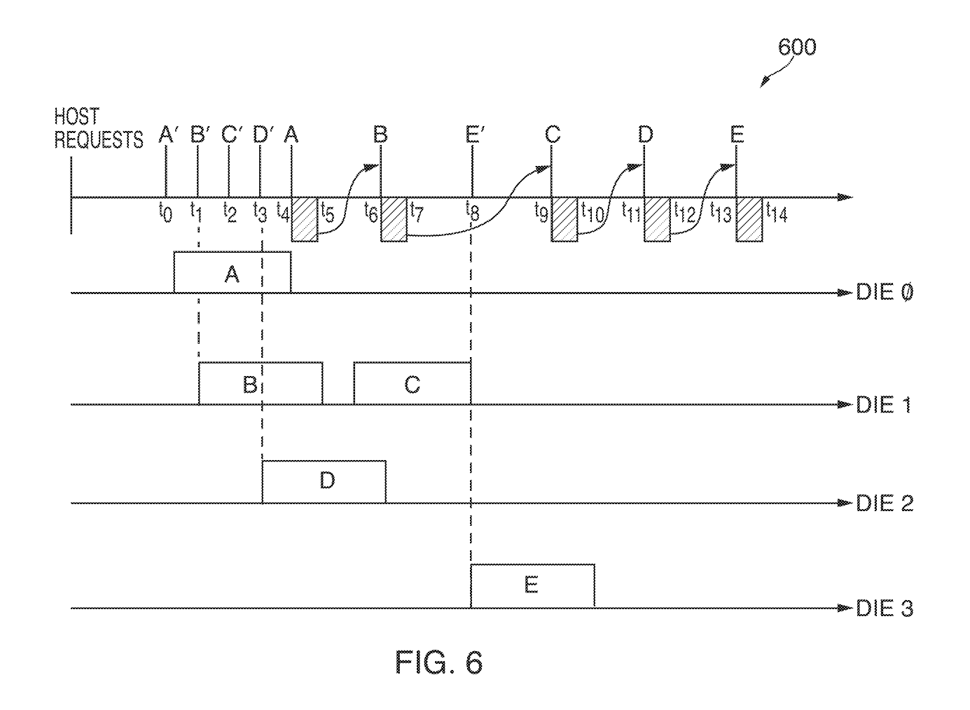

For example, turning now to FIG. 5, a graphical view of illustrative timing diagram 500 is shown. Normal read commands (e.g., data transfer read commands) in timing diagram 500 correspond to non-prime versions of read commands (e.g., read commands A, B, C, etc.), and non-data transfer read commands correspond to prime versions of read commands (e.g., read commands A′, B′, C′, etc.).

At t₀, in response to receiving a data request corresponding to logical sector A from an application, the host can transmit data transfer read command A to an NVM (e.g., NVM 120 of FIG. 1 or NVM 220) requesting data corresponding to logical sector A. Data transfer read command A can include a flag bit that is set to a data-phase value.

From the perspective of the NVM, once data transfer read command A is received, the NVM can translate the associated logical address and fetch data associated with logical sector A. The NVM can then transmit the data to the host over a bus (e.g., bus 130 of FIG. 1). Thus, similar to FIG. 4, the fetching and transmission process can produce a delay.

However, in contrast to FIG. 4, upon dispatching read command A, the host can determine one or more logical sectors that are highly associated with logical sector A. For example, the host can determine that logical sectors B, C, D, and E are all highly associated with logical sector A. As another example, the host can determine that logical sector B is most highly associated with logical sector A. Subsequently, the host can determine that, out of the remaining logical sectors, logical sector C has the highest association with logical sector B. The host can repeat this process of determining highly associated logical sectors until it has exhausted the deterministic read patterns associated with the application.

After determining all of the logical sectors that are highly associated with logical sector A (e.g., logical sectors B-E), the host can dispatch non-data transfer read commands B′-E′ to the NVM, where each non-data transfer read command is associated with logical sectors B-E, respectively. Each of non-data transfer read commands B′-E′ can include a flag bit that is set to indicate that no data transfer is desired (e.g., a no-data-phase value). In some embodiments, non-data transfer read commands B′-E′ may be assigned the same opCode as data transfer read commands.

Non-data transfer read commands B′-E′ can be dispatched in any suitable manner. For example, because the NVM can fetch data corresponding to read commands B′-E′ in any suitable order (e.g., a first come, first serve order and/or an order that is dependent on the NVM die associated with each read command), the order in which read commands B′-E′ are dispatched by the host may be inconsequential. In some embodiments, the host can dispatch non-data transfer read commands B′-E′ in a sequential LBA order. In other embodiments, particularly if the host determines that the deterministic read patterns have a non-sequential LBA order, the host can dispatch non-data transfer read commands B′-E′ in a non-sequential LBA order. Thus, even if the host incorrectly predicts the actual order of data that is requested by the application, the NVM will nonetheless pre-fetch data for all dispatched non-data transfer read commands.

In addition, the host can dispatch non-data transfer read commands B′-E′ in a consecutive or non-consecutive manner. For example, as shown in FIG. 5, non-data transfer read commands B′-E′ can be dispatched in a non-consecutive manner. For instance, the host can dispatch non-data transfer read commands B′ and C′ at t₁ and t₂, respectively. However, non-data transfer read commands D′ and E′ may not be dispatched until the host has dispatched data transfer read command B.

Because non-data transfer read commands B′ and C′ can be dispatched while the host is waiting for the data associated with logical sector A, these non-data transfer dispatches do not occupy bus bandwidth that could otherwise be used for other data transfer access commands. Therefore, bus bandwidth can be efficiently utilized.

As shown in FIG. 5, once the NVM has received non-data transfer read commands B′ and C′, the NVM can synchronously read corresponding data from one or more blocks. In some embodiments, there may be a minor, fixed delay (e.g., 3-5 μs) between receipt of a non-data transfer read command and the subsequent fetching of corresponding data.

In some cases (e.g., particularly when data corresponding to read commands B′ and C′ are stored on different NVM dies), the NVM can efficiently pre-fetch data corresponding to multiple read commands in parallel. Consequently, concurrent reading of the NVM can occur despite the lack of a queued workload from the application. The efficiency of this process can further be improved because the pre-fetching can occur while the NVM is transmitting the data associated with logical sector A across the bus.

Additionally, rather than immediately transmitting the data associated with each of non-data transfer read commands B′-E′ across the bus, the NVM can store the data in a cache of the NVM (e.g., cache 128 of FIG. 1) while the NVM waits for associated data transfer read commands from the host. Because data pre-fetching can be performed without committing to any bus transactions, the bus can be freed up for other I/Os.

At a later time, the host may issue data transfer read commands corresponding to one or more of the previously dispatched non-data transfer read commands B′-E′. For instance, at t₅, in response to receiving a data request corresponding to logical sector B from the application, the host can dispatch corresponding data transfer read command B to the NVM. Like data transfer read command A, read command B can include a flag bit that is set to a data-phase value.

Similar to FIG. 4, the time interval between when data from a first data transfer read command is received by the host and when a second data transfer read command is dispatched by the host may be host-dependent (e.g., as indicated by the arrows in FIG. 5). For instance, after data associated with data transfer read command A has been received by the host, the application may need to process the data and then determine which read command(s) to issue next. Thus, a particular amount of time (e.g., t₅-t₄) may elapse before data transfer read command B is transmitted.

In response to receiving data transfer read command B, the NVM can determine that read command B corresponds to a logical sector (e.g., logical sector B) that already has data stored in the cache. Because the NVM has pre-buffered the data corresponding to logical sector B in the cache, the NVM can quickly perform a cache lookup of the data. Upon locating the data, the NVM can immediately transmit the data across the bus.

There may be a minimal latency (e.g., a few microseconds) associated with the transfer time. For instance, as shown in FIG. 5, the transfer time is equal to the time interval between the dispatch of data transfer read command B at t₅ and the subsequent receipt of data by the host at t₆.

Similarly, for logical sectors C, D, and E, the host can transmit data transfer read commands C, D, and E to the NVM requesting data at t₉, t₁₁, and t₁₃, respectively. In each of these instances, because the NVM has already pre-buffered the corresponding data, the NVM can perform a cache lookup, and immediately transmit the data over the bus. Consequently, each of these data transfer read commands could be completed in the time that it takes to transfer the data to the host. Hence, although transfer time latencies and host-dependent latencies cannot be controlled, the system can avoid latencies associated with fetching data in the NVM so long as the data pre-fetching occurs before corresponding data transfer read commands are dispatched from the host.

As discussed, the NVM can pre-fetch data corresponding to non-data transfer read commands in any suitable order. In some embodiments, the NVM can pre-fetch data in an opportunistic order so as to maximize fetching concurrencies. For example, the NVM can fetch the data based on an order that is dependent on the NVM die associated with each read command.

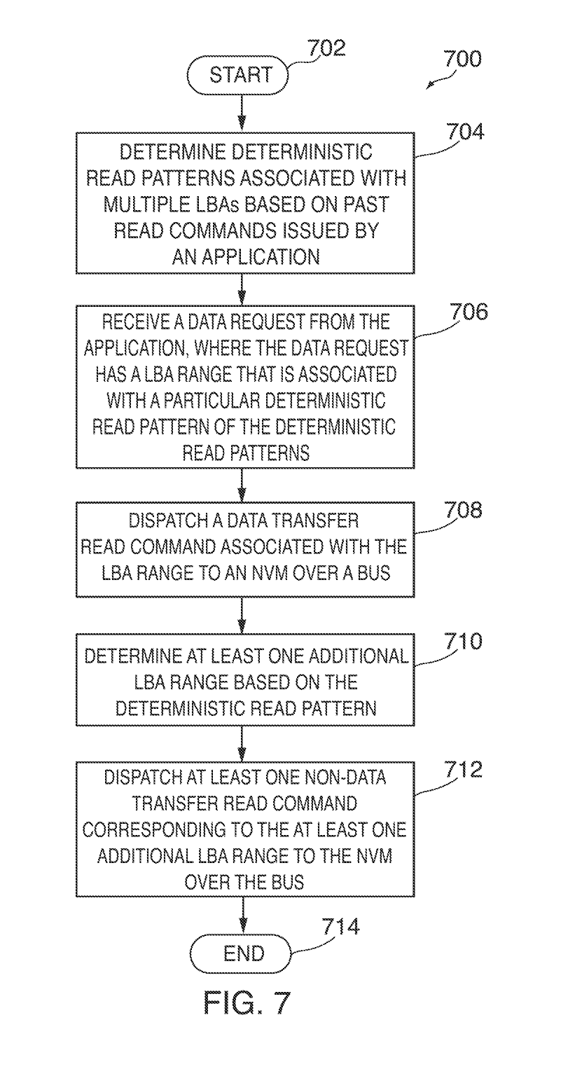

Turning now to FIG. 6, a graphical view of illustrative timing diagram 600 is shown. Similar to FIG. 5, normal read commands (e.g., data transfer read commands) in timing diagram 600 correspond to non-prime versions of read commands (e.g., read commands A, B, C, etc.), and non-data transfer read commands correspond to prime versions of read commands (e.g., read commands A′, B′, C′, etc.). Each non-data transfer read command can include a flag bit that is set to indicate that no data transfer is desired (e.g., a no-data-phase value).

As shown in FIG. 6, between t₀ and t₃, a host (e.g., SoC 110 of FIG. 1) can dispatch non-data transfer read commands A′-D′, respectively, to the NVM. Each non-data transfer read command can be associated with logical sectors A-D, respectively.

The order in which the non-data transfer read commands are serviced can depend on one or more factors. For example, if each non-data transfer read command is associated with a different die, the non-data transfer read commands can be serviced concurrently and on a first come, first serve order. For example, if non-data transfer read commands A′, B′, D′, and E′ are associated with Dies 0-3 of an NVM, respectively, these non-data transfer read commands can be serviced in the order that they are received (e.g., data associated with non-data transfer read command A′ is pre-fetched first, followed by data associated with non-data transfer read command B′, etc.). As a result, during certain periods of time, multiple non-data transfer read commands can be serviced concurrently (e.g., at t₃, the NVM can be pre-fetching data associated with non-data transfer read commands A′, B′, and D′).

However, if there is a conflict or collision between two or more of the non-data transfer read commands (e.g., when two or more of the non-data transfer read commands are associated with the same die), at least a subset of the non-data transfer read commands may not be able to be serviced concurrently. For example, if non-data transfer read command B′ and C′ are both associated with Die 1, non-data transfer read command C′ may be serviced only after data associated with non-data transfer read command B′ has been fetched. This is because die resource conflicts on a particular die may allow only one operation to be performed during a given time. Thus, non-data transfer read commands that collide in an NVM queue (e.g., NVM queue 130 of FIG. 1) will be serviced in a first come, first serve order (e.g., the servicing of a later arriving command is delayed until the earlier command has completed).

Consequently, in some cases, non-data transfer read commands may be serviced out of order. For example, as shown in FIG. 6, although non-data transfer read command C′ arrived before non-data transfer read command D′, read command D′ is serviced on Die 2 before read command C′ is serviced on Die 1 because read command D′ does not conflict with non-data transfer read command B′.

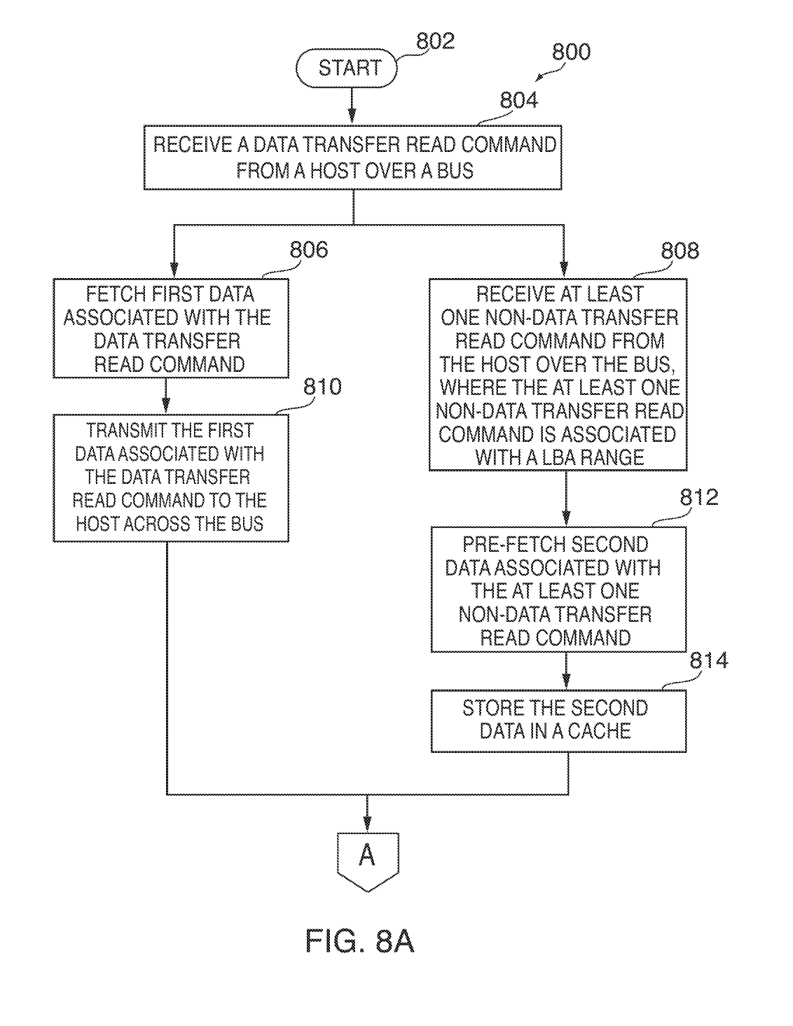

Turning now to FIG. 7, a flowchart of illustrative process 700 for dispatching one or more non-data transfer read commands from a host (e.g., SoC 110 of FIG. 1) is shown. Process 700 may begin at step 702, and at step 704, the host can determine deterministic read patterns associated with multiple LBAs based on past read commands issued by an application. For example, the host can determine that the application generally issues data requests for logical sector A, followed by logical sectors B-E.

Continuing to step 706, the host can receive a data request from the application, where the data request has a LBA range that is associated with a particular deterministic read pattern of the deterministic read patterns. For example, the host can receive a data request for logical sector A.

At step 708, the host can dispatch a data transfer read command associated with the LBA range to an NVM (e.g., NVM 120 of FIG. 1 or NVM 220 of FIG. 2) over a bus (e.g., bus 130 of FIG. 1). For example, an NVM interface (e.g., NVM interface 118 of FIG. 1 or NVM interface 218 of FIG. 2) can direct a bus controller (e.g., bus controller 216 of FIG. 2) to dispatch a data transfer read command A (FIG. 5) associated with logical sector A to the NVM. The data transfer read command can include a flag bit that is set to a data-phase value.

In some embodiments, the host can first store the data transfer read command in a queue (e.g., queue 116 of FIG. 1). Consequently, the host can dispatch the data transfer read command from the queue to the NVM.

Then, at step 710, the host can determine at least one additional LBA range based on the deterministic read pattern. For example, the host can determine that logical sectors B-E are all highly associated with logical sector A based on the deterministic read pattern.

At step 712, the host can dispatch at least one non-data transfer read command corresponding to the at least one additional LBA range to the NVM over the bus. For example, the NVM interface can direct the bus controller to dispatch non-data transfer read commands B′-E′ (FIG. 5) associated with logical sectors B-E, respectively, to the NVM. The at least one non-data transfer read command allows the NVM to pre-fetch data associated with the at least one additional LBA range without transmitting the data over the bus. In some embodiments, the at least one non-data transfer read command can include a flag bit that is set to indicate that no data transfer is desired (e.g., a no-data-phase value). Process 700 may then end at step 714.

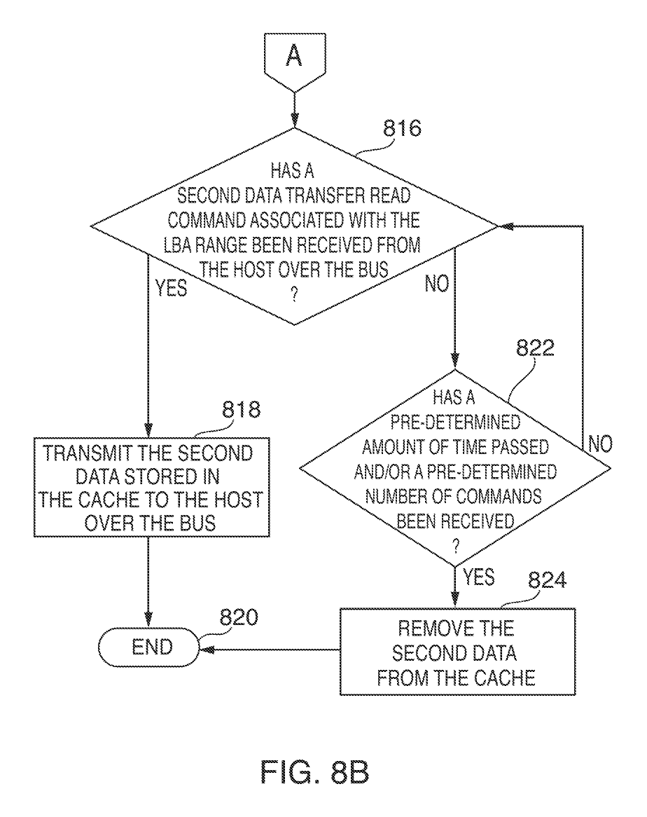

Turning now to FIGS. 8A and 8B, flowcharts of illustrative process 800 for handling non-data transfer read commands is shown. Process 800 may begin at step 802, and at step 804, an NVM (e.g., NVM 120 of FIG. 1 or NVM 220 of FIG. 2) can receive a data transfer read command from a host (e.g., SoC 110 of FIG. 1) over a bus (e.g., bus 130 of FIG. 1). For example, the NVM can receive data transfer read command A (FIG. 5) from the host.

Process 800 can then concurrently move to step 806 and step 808. At step 806, the NVM can fetch first data associated with the data transfer read command. Then, at step 810, the NVM can transmit the first data associated with the data transfer read command to the host across the bus.

In parallel with steps 806 and 810, at step 808, the NVM can receive at least one non-data transfer read command from the host over the bus, where the at least non-data transfer read command is associated with a LBA range. For example, the NVM can receive non-data transfer read commands B′-C′ (FIG. 5) from the host, where read commands B′-C′ are associated with logical sectors B and C, respectively.

Continuing to step 812, the NVM can pre-fetch second data associated with the at least one non-data transfer read command. At step 814, the NVM can store the second data in a cache of the NVM (e.g., cache 128 of FIG. 1). Thus, steps 808, 812, and 814 of process 800 can occur during a latency period associated with the fetching and/or transmission of the first data in steps 806 and 810.

From step 810 or step 814, process 800 may move to step 816. At step 816, the NVM can determine whether a second data transfer read command associated with the LBA range has been received from the host over the bus.

If, at step 816, the NVM determines that a second data transfer read command associated with the LBA range has been received from the host over the bus, process 800 may move to step 818. For example, the NVM may determine that the host has issued data transfer read command B. Then, at step 818, the NVM can transmit the second data stored in the cache to the host across the bus. Process 800 may then end at step 820.

Referring back to step 816, if the NVM instead determines that a second data transfer read command associated with the LBA range has not been received over the bus, process 800 may move to step 822. At step 822, the NVM can determine whether a pre-determined amount of time has passed or a pre-determined number of commands (e.g., 100 commands) have been received.

If, at step 822, the NVM determines that a pre-determined amount of time has not passed or a pre-determined number of commands have not been received, process 800 may return to step 816, where the NVM can continue to wait for the second data transfer read command associated with the LBA range. If, at step 822, the NVM instead determines that a pre-determined amount of time has passed or a pre-determined number of commands have been received, process 800 may move to step 824.

At step 824, the NVM can remove the second data from the cache. Process 800 may then end at step 820. Thus, at step 824, the NVM may have determined that the host did not need the data corresponding to the LBA range. Thus, the NVM may have unnecessarily consumed power in pre-fetching the second data and storing the second data in the cache. Nonetheless, this process may have only a minimal impact on overall system performance because the pre-fetching had no significant processing overlap with other operations. In addition, the NVM did not have to occupy additional bus bandwidth in transmitting the second data to the host.

It should be understood that processes 300, 700, and 800 of FIGS. 3, 7, and 8A-8B may be executed by one or more components in a system (e.g., electronic device 100 of FIG. 1 or electronic device 200 of FIG. 2).

It should also be understood that processes 300, 700, and 800 of FIGS. 3, 7, and 8A-8B are merely illustrative. Any of the steps may be removed, modified, or combined, and any additional steps may be added, without departing from the scope of the invention.

The described embodiments of the invention are presented for the purpose of illustration and not of limitation.

What is claimed is:

1. A method for performing non-data transfer access commands, the method comprising:
receiving information from a non-volatile memory (“NVM”) indicating that the NVM supports a flag bit command format;
saving access commands in a queue stored in volatile memory, wherein at least a subset of the access commands are non-data transfer access commands, and wherein each non-data transfer access command comprises a flag bit that is set to indicate one of lack of data association and that no data transfer is desired; and
dispatching each of the access commands in the queue, wherein dispatches associated with the non-data transfer access commands have zero latencies.

2. The method of claim 1, wherein the flag bit is set to a no-data-phase value.

3. The method of claim 1, wherein at least one of the non-data transfer access commands is a non-data transfer write command.

4. The method of claim 3, wherein the non-data transfer write command corresponds to a queue-able trim command that is associated with one logical sector that needs to be invalidated.

5. The method of claim 2, wherein at least a subset of the access commands are data transfer access commands, and wherein each data transfer access command comprises the flag bit that is set to a data-phase value.

6. The method of claim 5, wherein the non-data transfer access commands have the same opCode as the data transfer access commands.

7. The method of claim 3, wherein the dispatching further comprises:
dispatching the non-data transfer write command; and
receiving a complete status associated with the non-data transfer write command from the NVM with no delay.

8. The method of claim 3, wherein the non-data transfer write command is handled by the NVM at a later time.

9. The method of claim 3, wherein the non-data transfer write command is executed by the NVM concurrently with other commands.

10. The method of claim 1, wherein at least one of the non-data transfer access commands is a non-data transfer read command.

11. The method of claim 10, wherein the non-data transfer read command corresponds to an anticipatory fetch command with no data transfer.

12. A system comprising:
a non-volatile memory (“NVM”);
a bus;
a bus controller operative to communicate with the NVM over the bus; and
control circuitry operative to:
determine deterministic read patterns associated with a plurality of logical block addresses (“LBAs”) based on past read commands issued by an application;
receive a data request from the application, wherein the data request has a LBA range that is associated with a deterministic read pattern of the deterministic read patterns;
direct the bus controller to dispatch a data transfer read command associated with the LBA range to the NVM over the bus;
determine at least one additional LBA range based on the deterministic read pattern; and
direct the bus controller to dispatch at least one non-data transfer read command associated with the at least one additional LBA range to the NVM over the bus.

13. The system of claim 12, wherein the data transfer read command comprises a flag bit set to a data-phase value, and wherein the at least one non-data transfer read command comprises a flag bit set to a no-data-phase value.

14. The system of claim 12, wherein the bus is a Serial Advanced Technology Attachment (“SATA”) bus.

15. The system of claim 12, further comprising first volatile memory comprising a queue, wherein the control circuitry is further operative to:
store the data transfer read command in the queue; and
direct the bus controller to dispatch the data transfer read command from the queue to the NVM.

16. The system of claim 12, wherein the NVM is operative to:
receive the data transfer read command from the control circuitry over the bus;
fetch first data associated with the data transfer read command; and
transmit the first data associated with the data transfer read command to the control circuitry across the bus.

17. The system of claim 16, wherein the NVM is operative to:
receive the at least one non-data transfer read command from the control circuitry over the bus; and
pre-fetch second data associated with the at least one non-data transfer read command during a latency period associated with the transmission of the first data across the bus.

18. The system of claim 17, wherein the NVM comprises second volatile memory comprising a cache, and wherein the NVM is operative to store the second data in the cache of the NVM.

19. The system of claim 18, wherein the control circuitry is operative to:
receive a second data request from the application associated with the at least one additional LBA range; and
direct the bus controller to dispatch a second data transfer read command associated with the at least one additional LBA range to the NVM across the bus.

20. The system of claim 19, wherein the NVM is operative to:
receive the second data transfer read command from the control circuitry over the bus; and
transmit the second data stored in the cache to the control circuitry across the bus.

21. The system of claim 18, wherein the NVM is operative to:
determine that a second data transfer read command associated with the at least one additional LBA range has not been received over the bus after a pre-determined amount of time; and
remove the second data from the second volatile memory.

22. A memory interface for accessing a non-volatile memory (“NVM”), the memory interface comprising:
a bus controller operative to communicate with the NVM; and
control circuitry operative to:
track read behavior of an application over a period of time to determine non-random read patterns;
upon receiving a data request corresponding to a logical block address (“LBA”) range from the application, determine a plurality of LBA ranges that are highly associated with the LBA range based on the non-random read patterns; and
direct the bus controller to dispatch a set of non-data transfer read commands associated with the plurality of LBA ranges across a bus, thereby allowing the NVM to pre-fetch data associated with the plurality of LBA ranges without transmitting the data to the control circuitry.

23. The memory interface of claim 22, wherein the control circuitry is operative to dispatch the set of non-data transfer read commands in a non-sequential LBA order.

24. The memory interface of claim 22, wherein the control circuitry is operative to:
receive data requests corresponding to the plurality of LBA ranges;
dispatch data transfer read commands corresponding to the plurality of LBA ranges to the NVM over the bus; and
receive data associated with the data transfer read commands from the NVM with minimal latencies.
